(19) United States
(12) Patent Application Publication
(10) Pub. No.: US 2011/0018839 A1
(43) Pub. Date: Jan. 27, 2011

(54) TOUCH PANEL DISPLAY DEVICE

(75) Inventors: PO-SHENG SHIH, Miao-Li County (TW); JIA-SHYONG CHENG, Miao-Li County (TW)

Correspondence Address: Altis Law Group, Inc.;ATTN: Steven Reiss, 288 SOUTH MAYO AVENUE, CITY OF INDUSTRY, CA, 91789, US

(73) Assignee: CHIMEI INNOLUX CORPORATION, Miao-Li County (TW)

(21) Appl. No.: 12/840,300

(22) Filed: Jul. 21, 2010

(30) Foreign Application Priority Data
Jul. 24, 2009 (CN) 200910304807.3

(51) Int. Cl. G06F 3/045

(52) U.S. Cl. 345/174

(57) ABSTRACT

A touch panel display device includes an upper substrate and a lower substrate opposite to the upper substrate. The lower substrate includes scan lines, data lines intersecting with the data lines and contact sensor modules. Each contact sensor module includes a readout line spaced from the data lines, a readout component, and a contact detection module. The readout component includes two ports connected to the readout line and the scan line, respectively; and an equivalent resistance of the readout component is changed according to an electrical field formed between the common electrode and the readout component, such that an output voltage or an output current of the readout line is changed. The contact detection module detects a contact position via a position of the readout line of which the voltage or the current has been changed and a position of the scanned scan line.

### BACKGROUND

1. Technical Field

The present disclosure relates to touch panel display devices, and particularly, to a touch panel display device with an internal touch panel.

2. Description of the Related Art

Many digital devices, such as mobile phones, personal digital assistants (PDAs), and cameras currently utilize a touch panel display. Many such devices deploy an external touch panel, such as a capacitive or resistive touch panel. However, the thickness, weight and cost of the device are increased by the external touch panel. In addition, the light intensity and contrast of the display device are degraded with the use of the external touch panel.

Accordingly, some manufacturers have developed touch panel display devices having internal touch panels. For example, the Pat Green Planar Systems company provides a touch panel display device with an internal optical touch panel. The touch panel display device includes a plurality of TFTs (Thin-film Transistor). Each TFT has an amorphous silicon layer for sensing ambient light. Leakage current of the amorphous silicon layer is changed according to the intensity of the ambient light. Upon contact with the touch panel, the amorphous silicon layers corresponding to the contact position may not receive ambient light, thereby changing the leakage current of the amorphous silicon layer which is registered by the device.

However, the device may not detect the contact position under lower illuminative intensity circumstances, and, furthermore, because the TFTs when exposed in the ambient light may be degraded with use, thus continually generating a leakage current, which can generate mistaken detection of the contact position.

Therefore, there is room for improvement within the art.

### SUMMARY

An embodiment of the disclosure discloses a touch panel display device including an upper substrate and a lower substrate. The lower substrate is opposite to the upper substrate, and includes a plurality of scan lines, a plurality of data lines intersecting with the plurality of scan lines, and a plurality of contact sensor modules. Each contact sensor module includes a readout line spaced from the data lines, a readout component, and a contact detection module. The readout component includes two ports connected to the readout line and the adjacent scan line respectively, and an equivalent resistance of the readout component is changed according to an electrical field formed between the common electrode and the readout component, such that an output voltage or an output current of the adjacent readout line is changed. The contact detection module detects a contact position via a position of the readout line of which the output voltage or the output current has been changed and a position of the scanned scan line.

An embodiment of the disclosure discloses a touch panel display device including an upper substrate and a lower substrate. The lower substrate is opposite to the upper substrate, and includes a plurality of scan lines, a plurality of data lines intersecting with the plurality of scan lines, and a plurality of contact sensor modules. Each contact sensor module includes a readout line spaced from the data lines, a contact switch transistor, a readout component, and a contact detection module. The switch transistor includes a drain electrode, a source electrode, and a gate electrode. The source electrode is electrically connected to the adjacent readout line and the gate electrode is electrically connected to the adjacent scan line. The readout component disposed on an intersection of the readout line and the adjacent scan line includes two ports connected to the readout line and the adjacent scan line respectively, and the equivalent resistance of the readout component is changed according to an electrical field formed between the common electrode and the readout component, such that an output voltage or an output current of the adjacent readout line is changed. The contact detection module detects a contact position via a position of the readout line of the voltage or the output current being changed and a position of the scanned scan line.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is a partial cross-section of a first embodiment of a touch panel display device.

FIG. 2 is a partial view of an equivalent circuit of the touch panel display device of FIG. 1.

FIG. 3 is similar to FIG. 1, but showing the touch panel display device in a contact state.

FIG. 4 is a partial cross-section of a second embodiment of a touch panel display device.

FIG. 5 is a partial view of an equivalent circuit of a third embodiment of a touch panel display device.

FIG. 6 is a partial view of an equivalent circuit of a fourth embodiment of a touch panel display device.

### DETAILED DESCRIPTION

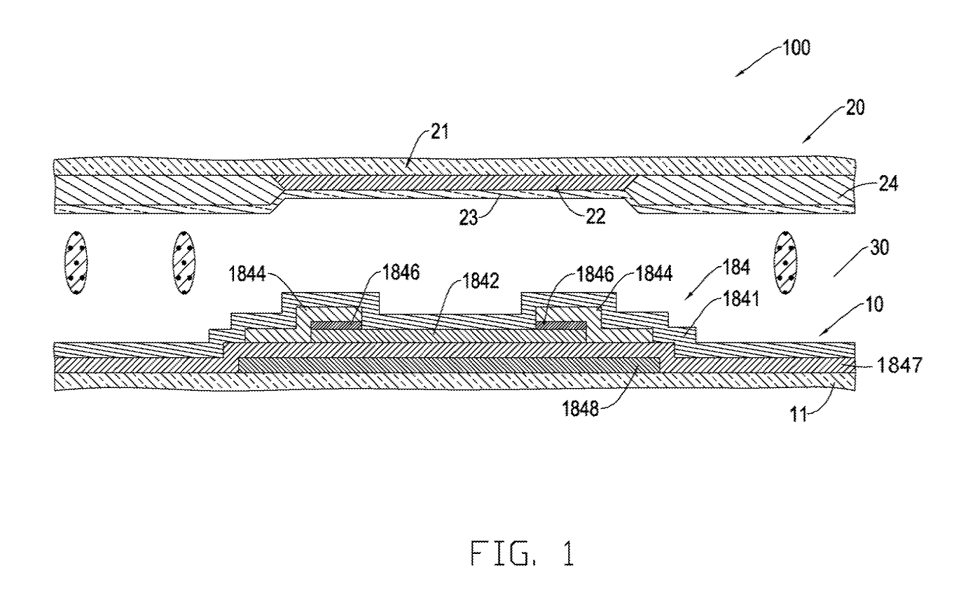

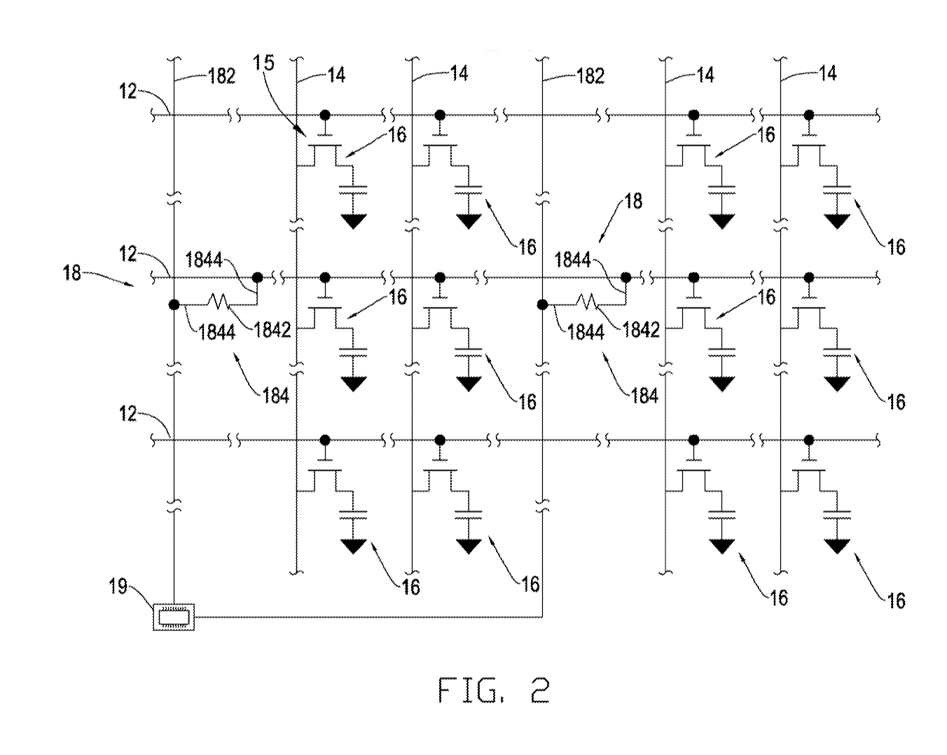

Referring to FIGS. 1 and 2, a first embodiment of a touch panel display device 100 includes a lower substrate 10, an upper substrate 20, and a liquid crystal layer 30. The lower substrate 10 is parallel to the upper substrate 20. The liquid crystal layer 30 is sandwiched between the lower substrate 10 and the upper substrate 20.

The upper substrate 20 includes a main body 21, a black matrix 22, a common electrode 23, and a plurality of color filters 24. The color filters 24 are disposed on a surface of the main body 21 opposite to the lower substrate 10. The black matrix 22 is disposed between the color filters 24. The black matrix 22 is a non-transparent film having a grid shape. The common electrode 23 is plated on an outer surface of the color filter 24 and the black matrix 22.

The lower substrate 10 includes a main body 11 and a plurality of scan lines 12 (see FIG. 2), a plurality of data lines 14, a plurality of sub-pixel control modules 16, a plurality of contact sensor modules 18, and a contact detection module 19. The scan lines 12 are evenly spaced from each other, and arranged on a surface of the main body 11 opposite to the upper substrate 20. The date lines 14 are evenly spaced from each other, and intersect the scan lines 12. The scan lines 12 and the date lines 14 cooperatively define a plurality of sub-pixel areas 15. The sub-pixel control modules 16 are disposed on the corresponding sub-pixel areas 15, respectively. The contact sensor modules 18 are disposed on a surface of the main body 11 adjoining the scan lines 12. The contact detection module 19 is disposed on a surface of the main body 11, and is electrically connected to the contact sensor modules 18.

Each sub-pixel control module 16 includes a display control transistor (not labeled) and a sub-pixel electrode (not shown). The display control transistor is electrically connected to the adjacent scan line 12, the adjacent data line 14, and the sub-pixel electrode. The sub-pixel electrode is a transparent electric film. The sub-pixel electrode is ITO (Indium Tin Oxide) or IZO (Indium Zinc Oxide). An electrical field is generated between the common electrode 23 and the sub-pixel electrode. The electrical field controls the rotation of the liquid crystal polymers of the liquid crystal layer 30. The touch panel display device 100 further includes a driving control module (not shown). The driving control module is electrically connected to the scan lines 12 and the data lines 14. The driving control module controls the on-off states of the display control transistor and the voltages of the sub-pixel electrode.

Each contact sensor module 18 includes a readout line 182 and a readout component 184. The readout line 182 is disposed between and parallel to the data lines 14. The readout component 184 is a resistive sensor component having two ports (not labeled). The two ports are respectively electrically connected to the adjacent readout line 182 and the adjacent scan line 12.

Each readout component 184 includes a protective layer 1841, a sensor layer 1842, two connecting members 1844, two ohmic contact layers 1846, an insulating layer 1847, and light shielding layer 1848. The light shielding layer 1848 is plated on a surface of the main body 11 facing the upper substrate 20. The insulating layer 1847 covers the light shielding layer 1848 and the main body 11. The sensor layer 1842 is plated on an outer surface of the insulating layer 1847. The two ohmic contact layers 1846 are disposed on opposite ends of the sensor layer 1842 to expose a middle portion of the sensor layer 1842. The two connecting members 1844 covers the ohmic contact layers 1846, respectively, and are disposed on an outer surface of the insulating layer 1847. The protective layer 1841 covers the insulating layer 1847, the connecting members 1844 and the middle portion of the sensor layer 1842. The light shielding layer 1848 is manufactured by a standard process of a gate metal layer of the display control transistor.

In the illustrated embodiment, the sensor layer 1842 is made of an amorphous silicon material. The sensor layer 1842 is disposed opposite to the black matrix 22, such that the sensor layer 1842 is not irradiated by an outside light through the black matrix 22. The sensor layer 1842 is disposed opposite to the light shielding layer 1848, such that the sensor layer 1842 is not irradiated by light from a backlight module (not shown) of the touch panel display 100. Therefore, the black matrix 22 and the light shielding layer 1848 prevent the sensor layer 1842 from generating a photo-induced leakage current.

In the illustrated embodiment, an area and shape of the sensor layer 1842 is formed based on the sub-pixel control module 16. The sensor layer 1842 is substantially a strip. Opposite ends of the sensor layer 1842 are electrically connected to the adjacent readout line 182 and the adjacent scan line 12. Each ohmic contact layer 1846 is formed between one connecting member 1844 and the sensor layer 1842 to avoid forming a non-ohmic contact resistance. The ohmic contact layer 1846 is manufactured by a doping process.

The contact detection module 19 is electrically connected to the readout lines 182. The contact detection module 19 detects a contact position via a position of the readout line of which the output voltage or the output current has been changed and a position of the scanned scan line 12. In the illustrated embodiment, the contact detection module 19 includes a comparator circuit (not shown) and a readout chip (not shown). The comparator circuit is electrically connected to the readout lines 182. The comparator circuit detects the change of the output voltage or the output current of the readout lines 182. The readout chip is electrically connected to the comparator circuit. The readout chip accepts a comparative signal from the comparator circuit and a control signal form the driving control module, such that the readout chip detects the readout component 184 via the readout lines 182.

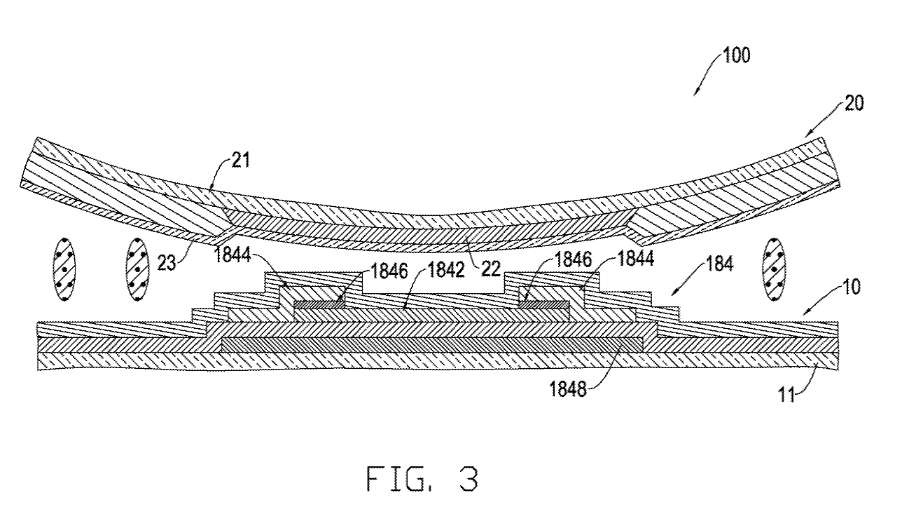

Referring to FIG. 3, the driving control module imports a pulse voltage to the scan lines 12 by a scanning method, such that the touch panel display device 100 maintains display function. A frequency of the scanning method can be 60 HZ, 120 HZ, and so on. Contact with the upper substrate 20 causes the contact position to bow toward the lower substrate 10. Free charges of the sensor layer 1842 of the readout component 184 are attracted by the common electrode 23, and are accumulated on a surface of the sensor layer 1842 facing the common electrode 23. Equivalent resistances of the opposite ends of the sensor layer 1842 are changed accordingly. The common electrode 23 attracts the free charges due to an electrical field formed between the common electrode 23 and a circuitry of the lower substrate 10 or between the common electrode 23 and the light shielding layer 1848. When the common electrode 23 moves toward the lower substrate 10, the electrical field is changed. This results in the equivalent resistances of opposite ends of the sensor layer 1842 changing as are the electrical field. When the sensor layer 1842 is capturing light intensity changes, if one of the scan lines 12 is in a continuous charge cycle, a resistance of the readout component 184 electrically connected to the scanned scan lines 12 is changed, such that the output voltage or the output current of the readout line 182 is changed. The contact detection module 19 detects the contact position via the readout line 182, the output voltage or current of which is changed and the scanned scan line 12. Effectively, when the scan line 12 is in a scanning period, the readout component 184 is touched off, such that the output voltage or the output current of the readout line 182 electrically connected to the readout component 184 is changed.

In the illustrated embodiment, the readout lines 182 and the scan lines 12 are electrically connected to a lower voltage power source (not shown). When the scan line 12 is not scanned, the electric potentials of the opposite ends of the sensor layer 1842 are equal, such that a current of the sensor layer 1842 of the readout component 184 is zero. When the scan line 12 is scanned, the voltage of the scan line 12 is changed from low to high; and the opposite ends of the readout component 184 generate a voltage difference, such that the readout component 184 exports an output current. If the readout component 184 is not touched, the output current of the readout component 184 is lower. If the readout component 184 is touched, the output current of the readout component 184 is higher. The contact detection module 19 detects a contact position corresponding to the touched readout component 184 based on the output current of the touched readout component 184.

It is to be understood that the number of readout components 184 may be no more than the data lines 14, or of the display control transistors. Therefore, an aperture ratio of the touch panel display device 100 is increased; and the cost reduced.

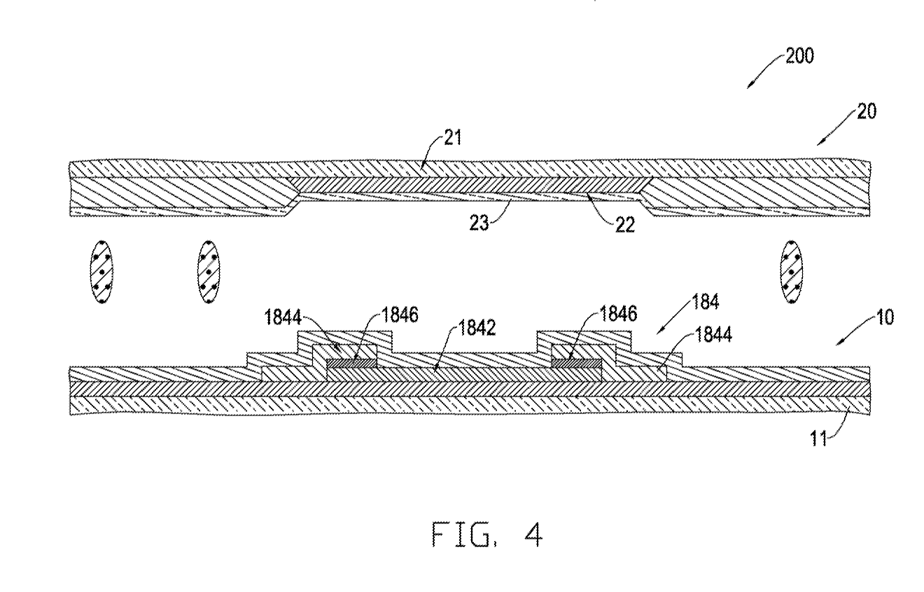

Referring to FIG. 4, a second embodiment of a touch panel display device 200 differs from the first embodiment only in that the light shielding layer 1848 is omitted. The sensor layer 1842 receives light from a backlight module (not shown), changing resistance thereof. Therefore, an area of the sensor layer 1842 may be decreased, and the aperture ratio and a brightness of the touch panel display device 200 are increased accordingly.

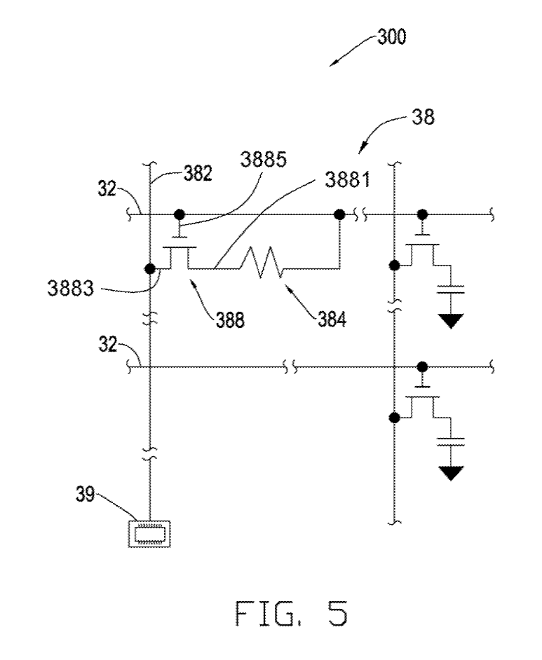

Referring to FIG. 5, a third embodiment of a touch panel display device 300 differs from the first embodiment only in that that the contact sensor module 38 of the touch panel display device 300 further includes a contact switch transistor 388. The contact switch transistor 388 connects in series with an end of the corresponding readout component 384 electrically connected to the readout line 382. The contact switch transistor 388 includes a drain electrode 3881, a source electrode 3883, and a gate electrode 3885. The drain electrode 3881 is electrically connected to the adjacent readout component 384. The source electrode 3883 is electrically connected to the adjacent readout line 382. The gate electrode 3885 is electrically connected to the adjacent scan line 32. The contact switch transistor 388 can increase the stability of an output current and voltage of the readout line 382. If the contact switch transistor 388 is omitted, when the scan line 32 is scanned, the readout component 384 exports a leakage current to the readout line 382 without contacting the touch panel display device 300, such that the accuracy of the contact detection module 39 is thereby decreased. However, if the contact switch transistor 388 is not omitted, when the scan line 32 is not scanned, the contact switch transistor 388 is closed, and thus there is no leakage current. Accordingly, the contact switch transistor 388 improves the degree of accuracy of the contact detection module 39. Furthermore, the voltage of the readout lines 382 is easily changed by the contact switch transistor 388.

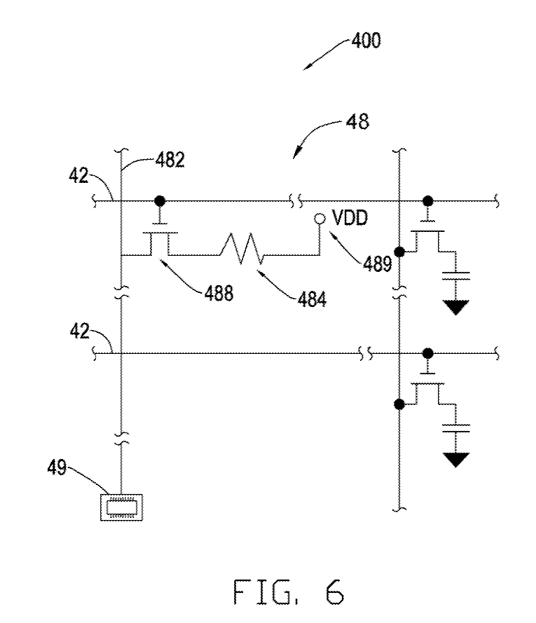

Referring to FIG. 6, a fourth embodiment of a touch panel display device 400 differs from the third embodiment of the touch panel display device 300 only in that the contact sensor module 48 of the touch panel display device 400 further includes a power source 489. Opposite ends of the readout component 484 are respectively electrically connected to the contact switch transistor 488 and the power source 489. The power source 489 supplies a readout voltage to the readout component 484. Therefore, the readout voltage of the readout component 484 is not limited by the maximum voltage of the scan lines 42.

Finally, while the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure as defined by the appended claims.

What is claimed is:

1. A touch panel display device, comprising:
an upper substrate comprising a common electrode; and
a lower substrate opposite to the upper substrate, the lower substrate comprising a plurality of scan lines, a plurality of data lines intersecting with the plurality of scan lines, and a plurality of contact sensor modules, each contact sensor module comprising:
a readout line spaced from the data lines;
a readout component disposed on an intersection of the readout line and the adjacent scan line, wherein the readout component includes two ports electrically connected to the readout line and the adjacent scan line, respectively, and an equivalent resistance of the readout component changes according to an electrical field formed between the common electrode and the readout component, such that an output voltage or an output current of the adjacent readout line is changed; and
a contact detection module electrically connected to the readout lines and detecting a contact position via a position of the readout line of which the output voltage or the output current has been changed and a position of the scanned scan line.

2. The touch panel display device of claim 1, wherein the readout component comprises a sensor layer made of an amorphous silicon material.

3. The touch panel display device of claim 2, wherein the readout component further comprises two connecting members, and the two ports of the readout component are connected to the adjacent readout line and the adjacent scan line via the connecting members, respectively.

4. The touch panel display device of claim 2, wherein the contact sensor module further comprises a light shielding layer disposed below the sensor layer.

5. The touch panel display device of claim 4, wherein the readout assembly further comprises two ohmic contact layers, manufactured by a doping process and interconnecting the connecting members and the sensor layer.

6. The touch panel display device of claim 2, further comprising a plurality of contact switch transistors disposed on a plurality of intersections of the scan lines and the readout lines.

7. The touch panel display device of claim 2, further comprising a black matrix disposed opposite to the sensor layer.

8. A touch panel display device, comprising:
an upper substrate comprising a common electrode; and
a lower substrate opposite to the upper substrate, the lower substrate comprising a plurality of scan lines, a plurality of data lines intersecting with the plurality of scan lines, and a plurality of contact sensor modules, each contact sensor module comprising:
a readout line spaced from the data lines;
a contact switch transistor comprising a drain electrode, a source electrode, and a gate electrode, wherein the source electrode is electrically connected to the adjacent readout line and the gate electrode is electrically connected to the adjacent scan line;
a readout component disposed on an intersection of the readout line and the adjacent scan line, wherein the readout component comprises two ports electrically connected to the readout line and the adjacent scan line respectively, and an equivalent resistance of the readout component is changed according to an electrical field formed between the common electrode and the readout component, such that an output voltage or an output current of the adjacent readout line is changed; and
a contact detection module electrically connected to the readout lines and detecting a contact position via a position of the readout line of which the output voltage or the output current has been changed and a position of the scanned scan line.

9. The touch panel display device of claim 8, wherein one of the two ports of the readout component is electrically connected to the adjacent scan line and a readout voltage of the readout component is provided by the adjacent scan line correspondingly.

10. The touch panel display device of claim 9, wherein the readout component comprises a sensor layer made of an amorphous silicon material.

11. The touch panel display device of claim 10, wherein the contact sensor module further comprises a light shielding layer disposed below the sensor layer.

12. The touch panel display device of claim 10, further comprising a black matrix disposed opposite to the sensor layer.

13. The touch panel display device of claim 8, wherein one of the two ports of the readout component is electrically connected to a power source, and the power source provides a readout voltage to the readout component.
